(19) United States
(12) Patent Application Publication
(10) Pub. No.: US 2006/0167602 A1
(43) Pub. Date: Jul. 27, 2006

(54) Operating device and in-vehicle electronic device

(75) Inventors: Yuji Matsumoto, Chiryu-city (JP); Ichiro Yoshida, Takahama-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/334,378

(22) Filed: Jan. 19, 2006

(30) Foreign Application Priority Data
Jan. 25, 2005 (JP) 2005-017055

(51) Int. Cl. G06F 7/00

(52) U.S. Cl. 701/36; 307/10.8

(57) ABSTRACT

A switch function selector collects vehicle's positional information and road data of roads surrounding the vehicle from a navigation device, and thereby determines whether the turn-signal lamps need controlling. When affirmatively determining, the switch function selector outputs an operating signal from a lever switch to a turn-signal lamp controller. When negatively determining, the switch function selector outputs the operating signal to a navigation device.

### CROSS REFERENCE TO RELATED APPLICATIONS

This application is based on and incorporates herein by reference Japanese Patent Application No. 2005-17055 filed on Jan. 25, 2005.

### FIELD OF THE INVENTION

The present invention relates to an operating device that outputs an operating signal in correspondence with an operation of an operating lever to control turn-signal lamps and illumination lamps of a vehicle, and further relates to an in-vehicle electronic device operable based on the operating signal outputted from the operating device.

### BACKGROUND OF THE INVENTION

In a vehicle such as an automobile, an operating lever to operate various car accessories, including illumination devices (e.g., headlights and position lamps) and turn-signal indicators, is provided on a steering column or the like. The operating lever is provided with various lever switches, and these lever switches detect an operation of the operating lever. The lever switches then output a detection signal to a turn-signal lamp controller to control blinking or light out of the turn-signal indicators, and further output an detection signal to an illumination lamp controller to control the headlights and the position lamps.

For example, when a user operates the operating lever in a vertical direction, the turn-signal lamp blinks or goes out, or when the user operates the operating lever in a horizontal direction (or back-and-forth direction), the headlights turn high-beam or low-beam state. Further, a rotating knob is provided around the axis of the operating lever, and the headlights and the position lamps (or width indicators) are turned on or off in correspondence with the user's rotation of the rotating knob.

In-vehicle electronic devices such as an audio device and a navigation device are mounted in the vehicle, and various operations are performed with operation switches, touch panels, remote controllers, and the like provided on/for these in-vehicle devices. When it is not necessary to operate the illumination devices and/or the turn-signal lamps with the operating lever, it is convenient to perform predetermined functions of these in-vehicle electronic devices using the operating lever.

Note that as the operating lever, an operating unit newly provided for operating in-vehicle electronic devices such as an audio device and a navigation device is known (for example, see Patent Document 1).

However, the in-vehicle electronic devices such as an audio device and a navigation device are not operated by the operating level itself, but are operated by the operating unit newly provided to the operating level.

Furthermore, if the accessory devices (such as illumination devices or turn-signal lamps) and the in-vehicle electronic devices (such as an audio device or a navigation device) are operated by the same operating lever, a selection operation is required.

Patent Document 1: JP-2001-67991A

### SUMMARY OF THE INVENTION

It is an object of the present invention to enable an operating lever to operate in-vehicle electronic devices such as an audio device or a navigation device without need of any other selection operation by a user or the like when it is not necessary to operate illumination devices or turning-signal lamps.

To achieve the above object, an operating device is provided with the following: An operating signal output unit is included for outputting an operating signal corresponding to an operation of an operating lever, which is used for controlling at least one of a turn-signal lamp and an illumination lamp of a vehicle. An information acquisition unit is included for acquiring information. A determination unit is included for determining based on the information acquired by the information acquisition unit whether or not the operating lever needs operating. An output selection unit is included for outputting an operating signal from the operating signal output unit to a control unit for controlling the at least one of the turn-signal lamp and the illumination lamp when the operating lever is determined to need operating, and for outputting an operating signal from the operating signal output unit to an in-vehicle electronic device for performing an operation corresponding to the operating signal when the operating lever is determined to not need operating.

Thus, when an operation of the turn-signal lamp or the illumination lamp by the operating lever is unnecessary, the operation of the in-vehicle electronic device can be started without any other selection operation by a user of the like.

### BRIEF DESCRIPTION OF THE DRAWINGS

FIG. 1 is a block diagram showing an overall construction of an operating device and an in-vehicle device according to a first embodiment of the present invention;

FIG. 2 is an explanatory diagram of a lever switch of the operating device according to the first embodiment;

FIGS. 3A and 3B are flowcharts showing selection processing by a switch function selector;

FIG. 4 is an explanatory diagram of right turning of a vehicle at an intersection;

FIG. 5 illustrates a display example when multiple selectable items are displayed on a display screen of a display unit of a navigation device;

FIG. 6 illustrates a display example when multiple windows are three-dimensionally arranged on the display screen of the display unit of the navigation device;

FIG. 7 illustrates a display example when a character selection screen and a search screen are displayed on the display screen of the display unit of the navigation device;

FIG. 8 is a block diagram showing an overall construction of an operating device and an in-vehicle electronic device according to a second embodiment;

FIG. 9 is a flowchart showing selection processing by a switch function selector of the operating device according to the second embodiment;

FIGS. 10A and 10B are an explanatory diagram and a schematic side view showing a structure of an operating lever of an operating device according to a third embodiment;

FIG. 11 is a schematic side view showing the structure of the operating lever of the operating device according to a fourth embodiment;

FIG. 12 illustrates a display example when multiple windows are three-dimensionally arranged by starting of multiple applications on a display screen of a display unit according to a fifth embodiment;

FIGS. 13A and 13B illustrate display examples when multiple windows are stereoscopically displayed by starting of multiple applications on a display screen of a display unit according to a sixth embodiment; and

FIG. 14 illustrates a display example when multiple windows are stereoscopically displayed by starting of multiple applications on a display formed on a windshield.

### DETAILED DESCRIPTION OF THE PREFERRED EMBODIMENTS

### First Embodiment

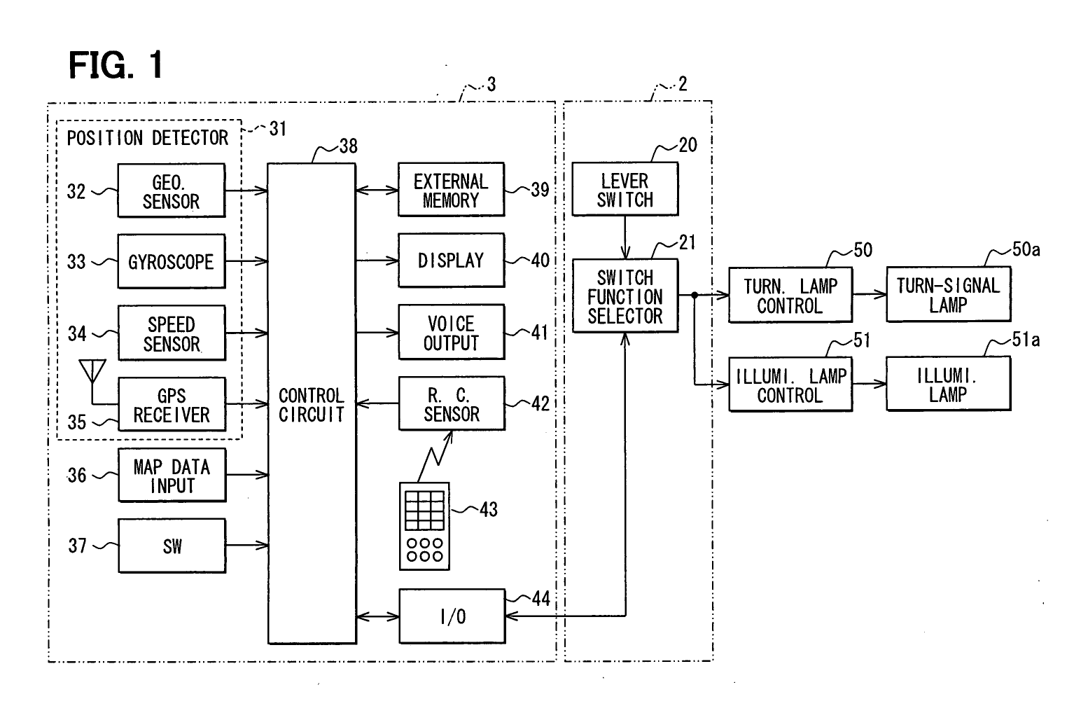

FIG. 1 shows an overall construction of an operating device and an in-vehicle electronic device according to a first embodiment of the present invention. In the present embodiment, a navigation device 3 will be described as the in-vehicle electronic device.

An operating device 2 has a lever switch 20 functioning as an operating signal output unit, and a switch function selector 21 functioning as a output selection unit. Further, the operating device 2 is connected respectively via cables with the navigation device 3, a turn-signal lamp controller 50, and an illumination lamp controller 51.

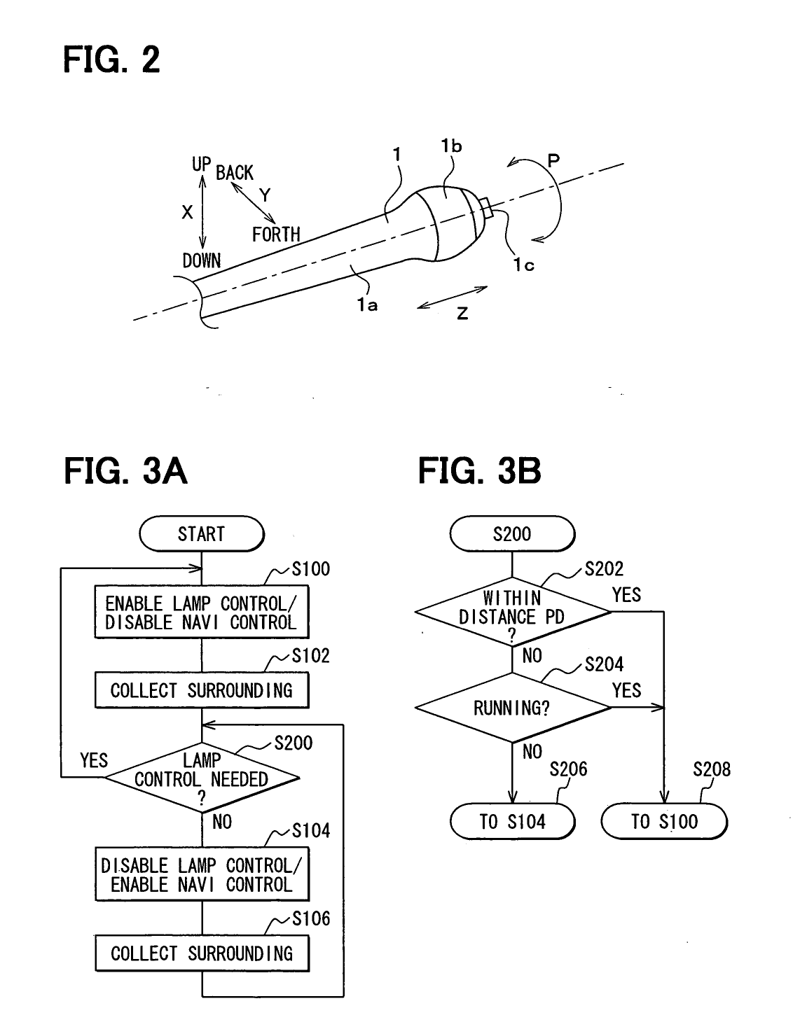

The lever switch 20 outputs an operating signal corresponding to an operation of each of (i) an operating lever 1 itself, (ii) a rotating knob 1b rotatably provided around an axis of a main lever 1a of the operating lever 1, and (iii) a determination button 1c provided at a distal end of the main lever 1a in an axial direction of the main lever 1a. A structure of the operating lever 1 is shown in FIG. 2. Note that the operating lever 1 is provided on a steering column of a vehicle (not shown).

The operating signal outputted from the lever switch 20 includes a vertical operating signal corresponding to an operation of the operating lever 1 in a vertical direction or up-and-down direction (X-direction), a horizontal operating signal corresponding to an operation of the operating lever 1 in a horizontal direction or back-and-forth direction (Y-direction), a rotational operating signal corresponding to a rotational operation of the rotating knob 1b in a rotational direction about the axis (P-direction) and an axial operating signal corresponding to an operation of the determination button 1c in the axial direction (Z-direction).

The switch function selector 21 has a selection switch and a microcomputer (both not shown). The selection switch is used for a selection of outputting of the operating signal inputted from the lever switch 20 to the turn-signal lamp controller 50 and the illumination lamp controller 51 or to the navigation device 3. The microcomputer controls the selection switch.

The microcomputer of the switch function selector 21 obtains vehicle position information, information indicating whether or not the vehicle is running, data of a road on which the vehicle is running, and the like, from the navigation device 3. The microcomputer determines based on the obtained various information whether or not it is necessary to control the turn-signal lamps, and controls selection by the selection switch in accordance with the result of determination. In other words, the microcomputer determines whether or not the turn-signal lamps are in a situation where the turn-signal lamps need to be controlled.

More particularly, when the switch function selector 21 determines that the turn-signal lamps need to be controlled, the switch function selector 21 causes the selection switch to output the operating signal inputted from the lever switch 20 to the turn-signal lamp controller 50 and the illumination lamp controller 51. When the switch function selector 21 determines that the turn-signal lamps do not need to be controlled, the switch function selector 21 causes the selection switch to output the operating signal inputted from the lever switch 20 to the navigation device 3.

The turn-signal lamp controller 50 controls blinking and light out of turn-signal lamps 50a provided left and right positions of the vehicle in correspondence with the operating signal inputted from the operating device 2.

The illumination lamp controller 51 controls lighting and light out of illumination lamps 51a including headlights and position lamps (or width indicators) of the vehicle in correspondence with the operating signal inputted from the operating device 2.

The navigation device 3 has a position detector 31, a map data input unit 36, an operation switch group 37, an external memory 39, a display unit 40, a voice output unit 41, a remote controller sensor 42, an input/output interface 44, and a control circuit 38 connected with these units. Here, the operation switch group 37 or the remote controller sensor 42 functions as an operating unit.

The position detector 31 has a well-known geomagnetic sensor 32, a gyroscope 33, a vehicle speed sensor 34, and a GPS receiver 35 to detect the position of the vehicle based on a radio wave from a satellite.

The map data input unit 36 holds various data, including so-called map matching data for improvement in position detection accuracy, map data, and road data, on a storage medium. The road data constructs a map by connecting multiple nodes such as an intersection with links. The road data includes unique numbers to specify links, link lengths, coordinates of start ends and terminal ends of the links, link road widths, intersection position information, and the like.

The operation switch group 37 includes input devices such as multiple push button switches (mechanical switches) provided around a display screen of the display unit 40 and a touch panel provided over the display screen. A signal in correspondence with a user's depression of a push button switch, the user's touching of the touch panel, or the like is outputted to the control circuit 38.

The external memory 39 is a storage unit provided in addition to an internal memory of the control circuit 38. The external memory 39, which is a ROM, a RAM, or the like, holds various data and programs.

The display unit 40, having a display screen such as a liquid crystal display, displays a video image on the display screen based on a video signal from the control circuit 38.

The voice output unit 41, having a speaker, outputs a voice from the speaker based on an audio signal from the control circuit 38.

The remote controller sensor 42 outputs a signal received from a remote controller 43, which transmits a radio signal by infrared communication or the like based on the user's operation, to the control circuit 38.

The input/output interface 44 performs communication with an external device. The input/output interface 44 transmits data inputted from the control circuit 38 to the external device, and receives a signal transmitted from the external device and outputs the signal to the control circuit 38. Note that the navigation device 3 performs communication with the operating device 2 via the input/output interface 44.

The control circuit 38 is a general computer having a CPU, a ROM, a RAM, a flash memory, an I/O, and the like.

The CPU of the control circuit 38 calculates the position of the vehicle based on a signal outputted from the position detector 31, and determines whether or not the vehicle is running based on a signal outputted from the vehicle speed sensor 34 of the position detector 31. Further, the CPU of the control circuit 38 obtains the road data (or road information) of roads within a predetermined range around the vehicle from the map data input unit 36.

Further, the CPU of the control circuit 38 displays a map display screen in which a vehicle mark is superposed on a vehicle position in a map, a search screen to perform a search for a destination, a route search screen in which a guide route to a destination is set, or the like, on the display screen of the display unit 40, in correspondence with the user's operation of the operation switch group 37 or the remote controller 43.

In the above construction, the microcomputer of the switch function selector 21 obtains the vehicle position, the information indicating whether or not the vehicle is running, and the road data within a predetermined range around the vehicle from the navigation device 3. Then the microcomputer determines based on these information whether or not it is necessary to control the turn-signal lamps, and based on the result of determination, performs selection processing to control selection by the selection switch.

Next, the selection processing will be described with reference to FIGS. 3A and 3B. FIG. 3A shows the entire flow of the selection processing. FIG. 3B shows the flow of turn-signal lamp control determination processing to determine whether or not it is necessary to control the turn-signal lamps at Step S200 in FIG. 3A. The switch function selector 21 starts the processing shown in FIG. 3A when the power is turned on.

First, the operation of the turn-signal lamp controller 50 and the operation of the illumination lamp controller 51 with the operating lever 1 is enabled, and the operation of the navigation device 3 is disabled (Step S100). More particularly, information indicating that the turn-signal lamp controller 50 and the illumination lamp controller 51 are operable with the operating lever 1 is displayed on a display screen of the navigation device 3; furthermore, the operating signal (X-direction, Y-direction, P-direction, or Z-direction) from the lever switch 20 is outputted from the selection switch of the switch function selector 21 to the turn-signal lamp controller 50 and the illumination lamp controller 51.

Note that in the navigation device 3 according to the present embodiment, the operating signal in the Y-direction is unused.

Next, information on surrounding circumstances of the vehicle is collected via the input/output interface 44 from the control circuit 38 of the navigation device 3 (Step S102). More particularly, the vehicle position information, the information indicating whether or not the vehicle is running, and the road data within the predetermined range around the vehicle are obtained. Note that as described above, the road data includes intersection position information.

Next, the turn-signal lamp control determination processing is performed based on the information on surrounding circumstances of the vehicle collected at Step S102, to determine whether or not the turn-signal lamps need controlling (Step S200). Note that the details of the turn-signal lamp control determination processing will be described later.

When it is determined that the turn-signal lamps need controlling (YES at Step S200), the process returns to the processing at Step S100.

Further, when it is determined at Step S200 that the turn-signal lamps do not need controlling (NO at Step S200), the operation of the turn-signal lamp controller 50 with the operating lever 1 is disabled, and the operation of the navigation device 3 is enabled (Step S104). More particularly, information indicating that the navigation device 3 is operable with the operating lever 1 is displayed on the display screen of the navigation device 3, and the operating signal (X-direction or Z-direction) from the lever switch 20 is outputted from the selection switch to the navigation device 3.

Next, as in the case of the processing at Step S102, the information on surrounding circumstances of the vehicle is collected via the input/output interface 44 from the control circuit 38 of the navigation device 3 (Step S106), and the process returns to the turn-signal lamp control determination processing at Step S200.

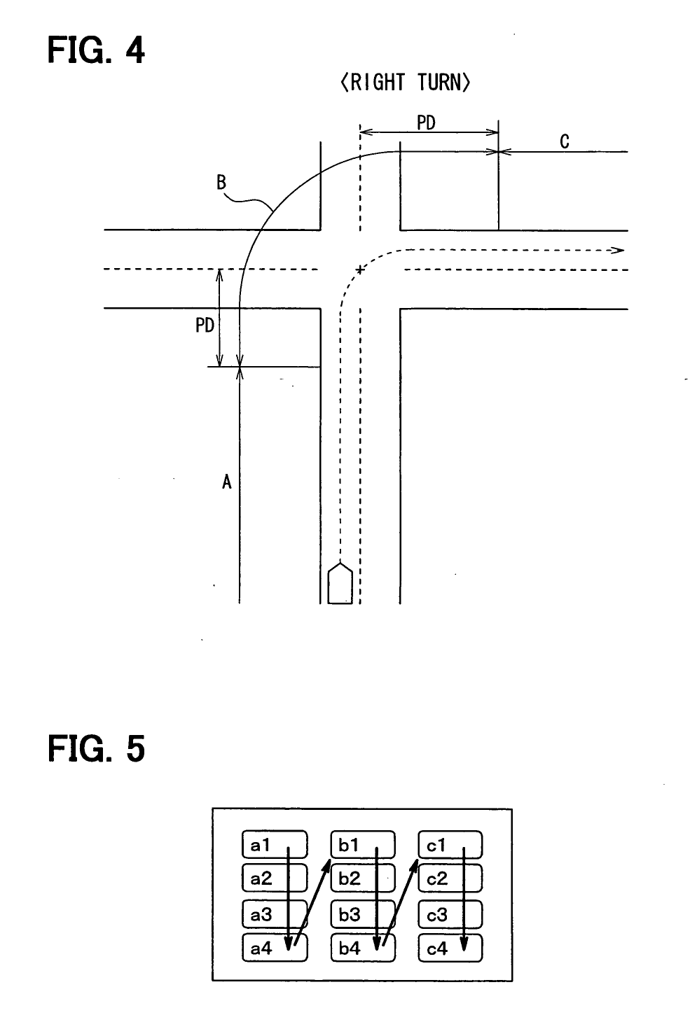

Next, the turn-signal lamp control determination processing at Step S200 in FIG. 3A will be described with reference to FIG. 3B and FIG. 4.

FIG. 4 shows the vehicle which is about to turn right at an intersection. Note that in FIG. 4, a section A indicates an area predetermined-distance PD (e.g., 200 m) before the intersection; a section B indicates an area from a point before the intersection by the predetermined-distance PD to a point ahead of the intersection after the vehicle's right turn within a predetermined distance PD (e.g., 200 m) from the intersection; and a section C indicates an area away from the intersection longer than the predetermined distance PD (e.g. 200 m).

First, when the vehicle is running in the section A without intersection at a predetermined or higher vehicle speed, it is determined based on the position of the intersection included in the road data and the current position of the vehicle that the distance to the next intersection is longer than a predetermined distance PD (NO at Step S202). Then it is determined that the vehicle is running (YES at Step S204), then it is determined that it is necessary to control the turn-signal lamps, and the process proceeds to Step S100 (Step S208).

Next, when the vehicle comes to the point predetermined-distance PD before the intersection then enters the section B while running at the predetermined or higher vehicle speed, it is determined based on the position of the intersection included in the road data and the current position of the vehicle that the distance to the next intersection is less than the predetermined distance PD (YES at Step S202). Then it is determined that the turn-signal lamps need to be controlled, and the process proceeds to Step S100 (Step S208).

Next, when the vehicle turns right at the intersection and comes to the point away from the intersection by the predetermined distance PD then enters the section C while running at the predetermined or higher vehicle speed, it is determined NO at Step S202, and it is determined YES at Step S204. Then it is determined that it the turn-signal lamps need to be controlled, and the process proceeds to step S100 (Step S208).

For example, when the vehicle stops in the section A or the section C in FIG. 4, it is determined based on the position of the intersection included in the road data and the current position of the vehicle that the distance between the vehicle and the intersection is equal to or longer than the predetermined distance PD (NO at Step S202), and it is determined that the vehicle stops (NO at Step S204). Then it is determined that the turn-signal lamps do not need controlling, and the process proceeds to Step S104 (Step S206).

As described above, the microcomputer of the switch function selector 21 obtains the vehicle position information and the road data around the vehicle, and determines whether or not the vehicle is positioned within the predetermined range from the intersection. When the microcomputer determines that the vehicle is positioned within a predetermined range from the intersection, the microcomputer determines that it is necessary to control the turn-signal lamps with the operating lever 1. On the other hand, when the microcomputer determines that the vehicle is not positioned within the predetermined range from the intersection, the microcomputer determines that it is not necessary to control the turn-signal lamps with the operating lever 1.

When it is determined by the microcomputer of the switch function selector 21 that it is necessary to control the turn-signal lamps with the operating lever 1, the selection switch of the switch function selector 21 outputs the operating signal from the lever switch 20 to the turn-signal lamp controller 50 and the illumination lamp controller 51. On the other hand, when it is determined by the microcomputer of the switch function selector 21 that it is not necessary to control the turn-signal lamps with the operating lever 1, the selection switch of the switch function selector 21 outputs the operating signal from the lever switch 20 to the navigation device 3.

Accordingly, when it is not necessary to operate the turn-signal lamps with the operating lever 1, the operation of an in-vehicle electronic device with the operating lever 1 can be performed without any selection operation by a user or the like.

Next, a display operation on the display unit 40 of the navigation device 3 by the operation of the operating device 2 will be described. The user can operate the remote controller 43, the push button switches of the operation switch group 37, and the touch panel of the operation switch group 37, and can perform predetermined functions of the navigation device 3 by the operation of the operating device 2.

Hereinafter, a selection display by the operation of the operating device 2 to display multiple selectable items on the display screen of the display unit 40 of the navigation device 3 will be described.

First, a display operation to two-dimensionally arrange multiple selectable items on the display screen of the display unit 40 of the navigation device 3 will be described.

FIG. 5 illustrates a display example when multiple selectable items are displayed on the display screen of the display unit 40 of the navigation device 3. As shown in FIG. 5, multiple selectable items a1 to a4, b1 to b4, and c1 to c4 are two-dimensionally arranged on the display screen of the display unit 40, and the item a1 is initially selected.

The control circuit 38 of the navigation device 3 performs the following display control in correspondence with the operating signal inputted from the operating device 2.

When the vertical operating signal indicating a downward direction is inputted from the operation unit 2 in correspondence with the user's operation of the operating lever 1 in the downward direction, a select-displayed item is changed in the downward direction from the item a1 to the item a2. Then, every time the user operates the operating lever 1 in the downward direction, the select-displayed item is changed in the downward direction from the item a2 to the item a3 and then from the item a3 to the item a4.

Next, when the vertical operating signal indicating the downward direction is inputted from the operating device 2 in correspondence with the user's operation of the operating lever 1 in the downward direction while the lowest item a4 is select-displayed, the top item b1 in the column right side of the item a4 is select-displayed. Then, every time the user operates the operating lever 1 in the downward direction, the select-displayed item is changed in the downward direction from the item b1 to the item b2 and then from the item b2 to the item b3.

Further, when the vertical operating signal indicating the downward direction is inputted from the operating device 2 in correspondence with the user's operation of the operating lever 1 in the downward direction while the lowest item c4 in the right-most column is select-displayed, the top item a1 in the left-most column is select-displayed.

Further, when the vertical operating signal indicating an upward direction is inputted from the operating device 2 in correspondence with the user's operation of the operating lever 1 in the upward direction, the select-displayed item is changed by one item in a direction opposite to the arrow in FIG. 5.

Further, when the vertical operating signal indicating the downward direction is continuously inputted from the operating device 2 in correspondence with the user's operation of the operating lever 1 in the downward direction, the select-displayed item is sequentially changed at predetermined periods in the direction of the arrow in FIG. 5. When the vertical operating signal indicating the upward direction is continuously inputted from the operating device 2 in correspondence with the user's operation of the operating lever 1 in the upward direction, the select-displayed item is sequentially changed at predetermined periods in the direction opposite to the direction of the arrow in FIG. 5.

When the axial operating signal corresponding to the depression of the determination button 1c of the operating device 2 is inputted from the operating device 2 while a particular item is select-displayed, predetermined processing related to the select-displayed item is performed.

Next, the display operation when multiple windows are three-dimensionally arranged on the display screen of the display unit 40 of the navigation device 3 will be described.

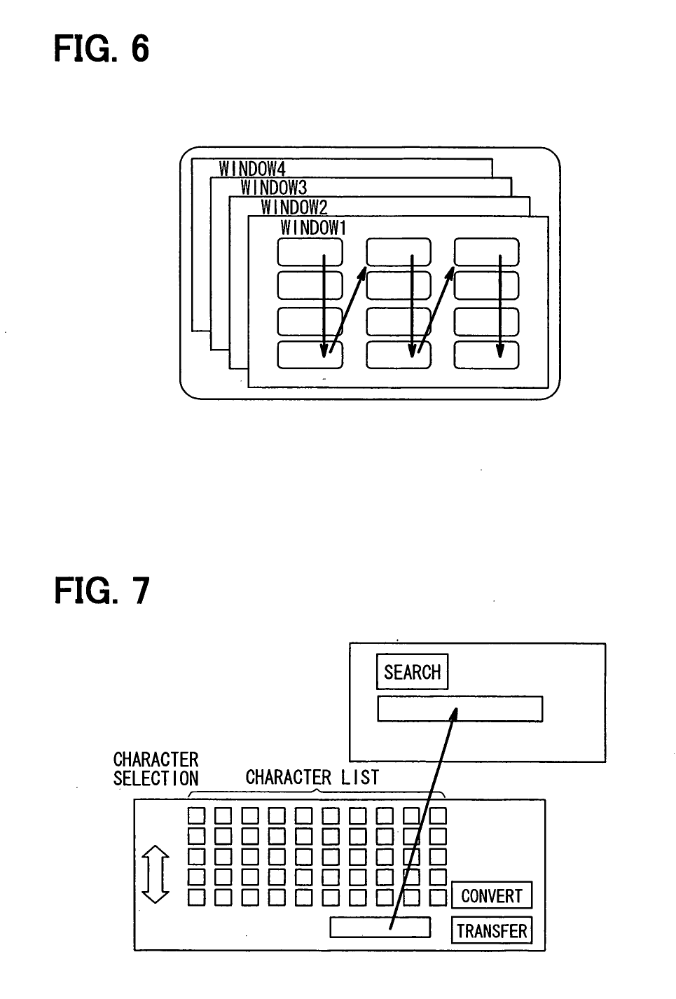

FIG. 6 illustrates a display example when multiple windows 1 to 4 are three-dimensionally arranged on the display screen of the display unit 40 of the navigation device 3. As shown in FIG. 6, in which the multiple windows 1 to 4 are displayed on the display screen of the display unit 40, when the rotational operating signal corresponding to the operation of the rotating knob 1b of the operating device 2 is inputted from the operating device 2, the control circuit 38 of the navigation device 3 performs display selection of an active window in correspondence with the rotational operating signal.

Note that the operation of select-display of each item in the window 1 in FIG. 6 can be performed in a similar manner to that in the above-described two-dimensional arrangement of multiple selectable items on the display screen of the display unit 40 of the navigation device 3.

Next, the display operation to display a character selection screen on the display screen of the display unit 40 of the navigation device 3 for character input in a character input field in correspondence with the display operation according to the character selection screen will be described.

FIG. 7 illustrates a display example when the character selection screen and a search screen are displayed on the display screen of the display unit 40 of the navigation device 3. As shown in FIG. 7, a “character list”, a “convert” key, a “transfer” key, and a character field for character input are displayed on the character selection screen.

These keys and field are selectable with the vertical operating signal inputted from the operating device 2 in correspondence with the user's operation of the operating lever 1.

More particularly, the control circuit 38 sequentially select-displays individual characters of the character list in correspondence with the vertical operating signal from the operating device 2 as in the case of the display example in FIG. 5. Further, when the vertical operating signal indicating the downward direction is inputted once from the operating device 2 while the lowest character in the right-most column of the character list is select-displayed, the control circuit 38 select-displays the character field. Then, when the vertical operating signal indicating the downward direction is further inputted once, the control circuit 38 select-displays the “convert” key. Then, when the vertical operating signal indicating the downward direction is further inputted once, the control circuit 38 select-displays the “transfer” key. Then, when the vertical operating signal indicating the downward direction is further inputted once, the control circuit 38 select-displays the top character in the left-most column of the character list.

The user can perform character input in the character field of the character selection screen, conversion of the character(s) inputted into the character field, transfer of the character(s) inputted in the character field to another screen, and the like, by operating the operating lever 1 in accordance with the character selection screen.

First, when the user selects a particular character in the character list by operating the operating lever 1 and operates the determination button 1c, the selected character is inputted into the character field.

Next, when the user selects the “convert” key by operating the operating lever 1 and operates the determination button 1c, the character in the character field is converted.

Next, when the user selects the “transfer” key by operating the operating lever 1 and operates the determination button 1c, the character in the character field is transferred to a character field in the search screen.

Note that the various operations may be performed by a combination of multiple operations of the operating lever 1. For example, it may be arranged such that when the user operates the operating lever 1 in the vertical direction while depressing the determination button 1c, an operation to move the window, or the like is performed.

Note that in the present embodiment, it is determined, based on the respective conditions such as the vehicle position information, the information indicating whether or not the vehicle is running, and the road data within the predetermined range around the vehicle, whether or not the turn-signal lamps need operating. However, the determination conditions are not limited to these conditions. For example, it may be arranged such that it is detected whether or not a shift lever has been set in a parking position, and it is determined based on the result of detection whether or not the turn-signal lamps need controlling.

Further, the microcomputer of the switch function selector 21 of the present embodiment causes the selection switch to output the operating signal from the lever switch 20 to the turn-signal lamp controller 50 and the illumination lamp controller 51 when the microcomputer determines that it is necessary to control the turn-signal lamps. However, it may be arranged such that the microcomputer causes the selection switch to output the operating signal from the lever switch 20 only to the turn-signal lamp controller 50. Further, in the present embodiment, the microcomputer causes the selection switch to output the operating signal (X-direction or Z-direction) from the lever switch 20 to the navigation device 3 when the microcomputer determines that it is not necessary to control the turn-signal lamps. Further, it may be arranged such that the operating signal (X-direction, Y-direction, P-direction, or Z-direction) from the lever switch 20 and a part of the operating signal (X-direction, Y-direction, P-direction, or Z-direction) from the lever switch 20 is selected and outputted to the navigation device 3.

### Second Embodiment

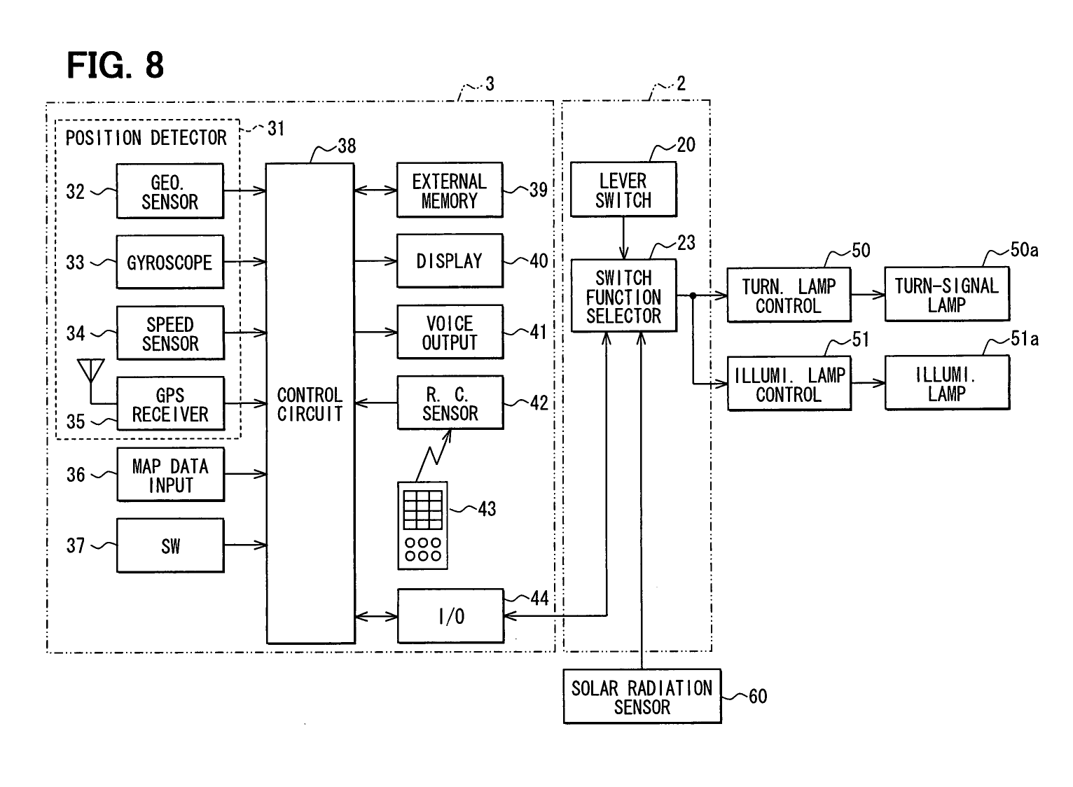

Next, a second embodiment will be described. In the description, mainly the difference between the second embodiment and the first embodiment will be explained. FIG. 8 shows an overall construction of the operating device and the in-vehicle electronic device according to the second embodiment. Note that constituent elements corresponding to those of the above-described first embodiment have the same reference numerals and the explanations of the elements will be omitted. Hereinafter, only the difference from the first embodiment will be described. As shown in FIG. 8, the operating device 2 has the lever switch 20 and a switch function selector 23 functioning as an output selection unit.

The switch function selector 23 obtains illumination intensity around the vehicle from a solar radiation sensor 60 provided in the vehicle, and determines based on the information whether or not it is necessary to control lighting/light out of the illumination lamps 51a including the headlights and position lamps. When the switch function selector 23 determines that it is necessary to control the illumination lamps 51a, the switch function selector 23 outputs the rotational operating signal from the lever switch 20 to the illumination lamp controller 51. When the switch function selector 23 determines that it is not necessary to control the illumination lamps 51a, the switch function selector 23 outputs the rotational operating signal from the lever switch 20 to the navigation device 3.

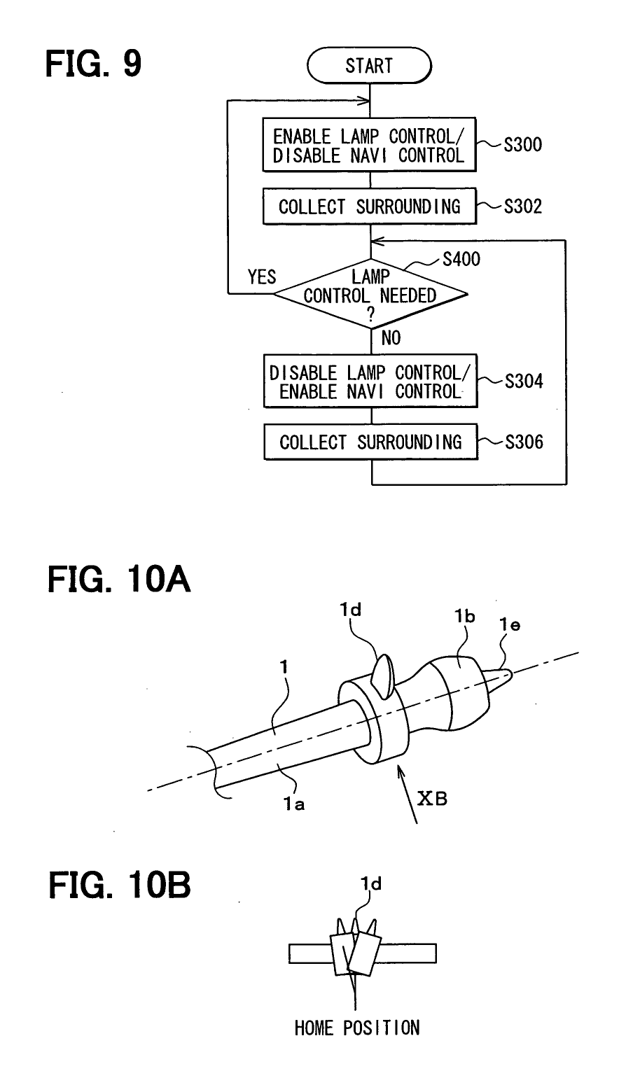

FIG. 9 is a flowchart showing the selection processing. The switch function selector 23 starts the selection processing when the power is turned on.

First, the operation of the turn-signal lamp controller 50 and the illumination lamp controller 51 with the operating lever 1 is enabled, and the operation of the navigation device 3 is disabled (Step S300). More particularly, information indicating that the turn-signal lamp controller 50 and the illumination lamp controller 51 are operable with the operating lever 1 is displayed on the display screen of the navigation device 3, and the operating signal (X-direction, Y-direction, P-direction, or Z-direction) from the lever switch 20 is outputted from the selection switch to the turn-signal lamp controller 50 and the illumination lamp controller 51.

Next, the illumination intensity around the vehicle is obtained as information on the surrounding circumstances of the vehicle from the solar radiation sensor 60 (Step S302).

Next, it is determined based on the illumination intensity around the vehicle obtained at Step S302 whether or not it is necessary to control the illumination lamps (Step S400). More particularly, when the illumination intensity around the vehicle is lower than a reference value, it is determined that it is necessary to control the illumination lamps. When the illumination intensity around the vehicle is equal to or higher than the reference value, it is determined that it is not necessary to control the illumination lamps.

When it is determined that it is necessary to control the illumination lamps (YES at Step S400), the process returns to the processing at Step S300.

Further, when it is determined at Step S400 that it is not necessary to control the illumination lamps (NO at Step S400), the operation of the illumination lamp controller 51 is disabled, and the operation of the navigation device 3 is enabled (Step S304). More particularly, information indicating that the navigation device 3 is operable with the operating lever 1 is displayed on the display screen of the navigation device 3, and the operating signal (P-direction or Z-direction) from the lever switch 20 is outputted from the selection switch to the navigation device 3.

Next, as in the case of the processing at Step S302, the information on the surrounding circumstances of the vehicle is collected from the control circuit 38 of the navigation device 3 and the solar radiation sensor 60 (Step S304), and the process returns to the processing at Step S400.

As described above, the microcomputer of the switch function selector 23 obtains the illumination intensity around the vehicle from the solar radiation sensor 60 provided in the vehicle, and determines based on the information whether or not the illumination lamps of the vehicle need controlling.

When the microcomputer of the switch function selector 23 determines that it is necessary to operate the illumination lamps with the operating lever 1, the selection switch of the switch function selector 23 outputs the operating signal from the lever switch 20 to the turn-signal lamp controller 50 and the illumination lamp controller 51. When the microcomputer determines that it is not necessary to control the illumination lamps, the selection switch outputs the operating signal from the lever switch 20 to the navigation device 3.

Accordingly, when it is not necessary to operate the illumination lamps with the operating lever 1, the operation of an in-vehicle electronic device with the operating lever 1 can be performed without selection operation by a user or the like.

Note that when the switch function selector 23 of the present embodiment determines that the illumination lamps need to be controlled, the switch function selector 23 causes the selection switch of the switch function selector 23 to output the operating signal from the lever switch 20 to the turn-signal lamp controller 50 and the illumination lamp controller 51. However, it may be arranged such that the operating signal from the lever switch 20 is outputted only to the turn-signal lamp controller 50, or only to the illumination lamp controller 51.

Further, the switch function selector 23 of the present embodiment obtains the illumination intensity around the vehicle from the solar radiation sensor 60 provided in the vehicle and determines whether or not the illumination lamps need controlling. However, the conditions for the determination are not limited to these conditions. For example, it may be arranged such that time information and calendar information are obtained from the navigation device 3, and it is determined based on the time information and the calendar information in addition to the illumination intensity whether or not the illumination lamps need controlling.

Further, when the microcomputer of the switch function selector 23 of the present embodiment determines that it is necessary to control the illumination lamps, the microcomputer causes the selection switch to output the operating signal from the lever switch 20 to the turn-signal lamp controller 50 and the illumination lamp controller 51. However, it may be arranged such that the operating signal from the lever switch 20 is outputted only to the illumination lamp controller 51. Further, when the microcomputer determines that it is not necessary to control the illumination lamps, the microcomputer causes the selection switch to output the operating signal (P-direction or Z-direction) from the lever switch 20 to the navigation device 3. However, it may be arranged such that the operating signal (X-direction, Y-direction, P-direction, or Z-direction) from the lever switch 20 and a part of the operating signal (X-direction, Y-direction, P-direction, or Z-direction) from the lever switch 20 is selected and outputted to the navigation device 3.

### Third Embodiment

FIGS. 10A and 10B show the structure of the operating lever 1 of the operating device 2 according to a third embodiment. FIG. 10A is a perspective view of the operating lever 1, and FIG. 10B is a schematic side view of a right-and-left-direction selection operating lever 1d viewed from an XB-direction in FIG. 10A.

The operating lever 1 of the operating device 2 according to the present embodiment, in comparison with the operating lever 1 in FIG. 2, is newly provided with a right-and-left-direction selection lever 1d as an attached operating unit. Further, a vertical-direction selection lever le in place of the determination button 1c shown in FIG. 2 is provided at the distal end portion of the operating lever 1.

As shown in FIG. 10B, the right-and-left-direction selection lever 1d is tilted in a right-and-left direction from a home position as a center in correspondence with the user's operation.

Further, the vertical-direction selection lever 1e is tilted in a vertical direction in correspondence with the user's operation.

The lever switch (not shown) according to the embodiment outputs a vertical operating signal corresponding to the operation of a main lever 1a in the vertical direction, a horizontal operating signal corresponding to the operation of the main lever 1a in the horizontal direction, a rotational operating signal corresponding to the operation of the rotating knob 1b, a right-and-left-direction selection operating signal corresponding to the operation of the right-and-left-direction selection lever 1d, and a vertical-direction selection operating signal corresponding to the operation of the vertical-direction selection lever 1e, to the switch function selector (not shown).

Further, the switch function selector according to the present embodiment has a similar hardware construction to that of the switch function selector 21 shown in the first embodiment.

As in the case of the switch function selector 21 shown in the first embodiment, the microcomputer of the switch function selector obtains the vehicle position information, the information indicating whether or not the vehicle is running, the road data of a road on which the vehicle is running, and the like, from the navigation device 3, determines based on the obtained various information whether or not the turn-signal lamps need controlling, and controls selection by the selection switch based on the result of determination.

More particularly, when the switch function selector determines that it is necessary to control the turn-signal lamps, the switch function selector causes the selection switch to output the operating signal inputted from the lever switch to the turn-signal lamp controller 50 and the illumination lamp controller 51. When the switch function selector determines that it is not necessary to control the turn-signal lamps, the switch function selector causes the selection switch to output the operating signal inputted from the lever switch to the navigation device 3.

Note that the right-and-left-direction selection operating signal corresponding to the operation of the right-and-left-direction selection lever 1d and the vertical-direction selection operating signal corresponding to the operation of the vertical-direction selection lever 1e are operating signals to operate a selection display on the display screen of the navigation device 3.

Further, as in the case of the switch function selector 21 shown in the first embodiment, the switch function selector of the present embodiment determines whether or not the turn-signal lamps need controlling, and controls the selection by the selection switch in accordance with the result of determination. However, it may be arranged, as in the case of the switch function selector 23 shown in the second embodiment, that the switch function selector obtains the illumination intensity around the vehicle from the solar radiation sensor provided in the vehicle, determines based on the information whether or not it is necessary to control lighting/light out of the turn-signal lamps 51a including the headlights and position lamps of the vehicle, and controls the selection by the selection switch in accordance with the result of determination.

### Fourth Embodiment

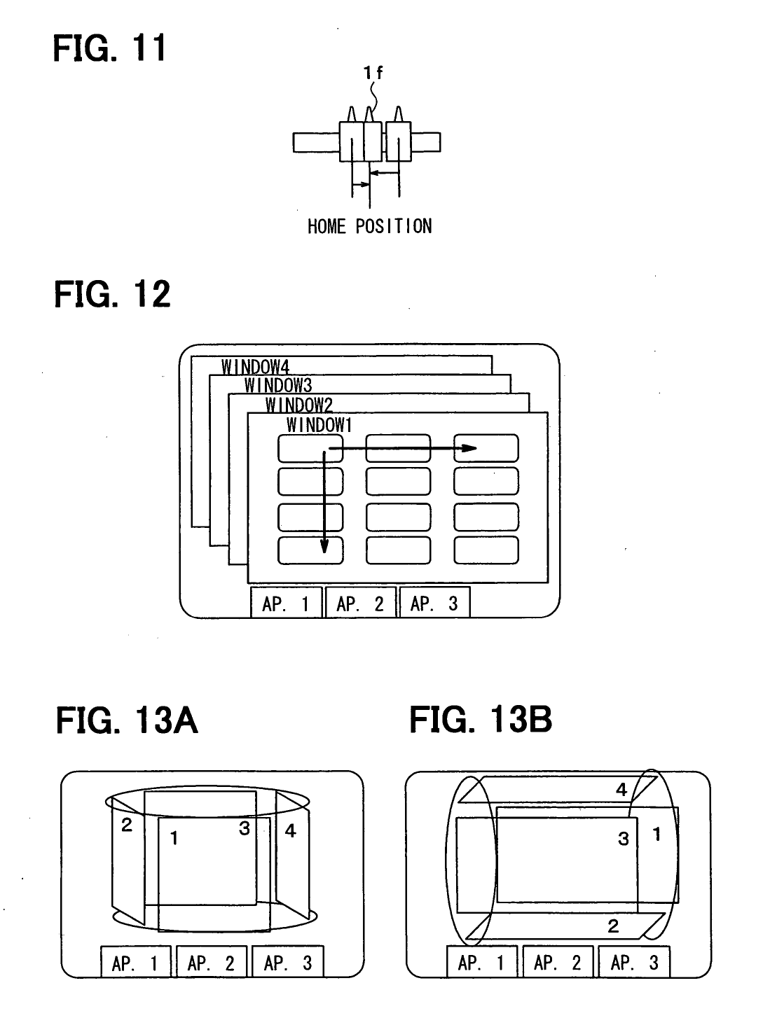

In the third embodiment, as shown in FIG. 10B, the right-and-left-direction selection lever 1d to be tilted in the right-and-left direction in correspondence with the user's operation is provided on the main lever 1a. As shown in FIG. 11, a right-and-left-direction selection lever 1f as an attached operating unit according to a fourth embodiment is provided so as to be moved in the axial direction of the main lever 1a with a home position as a center, in correspondence with the user's operation.

The lever switch (not shown) according to the present embodiment outputs a vertical operating signal corresponding to the operation of the main lever 1a in the vertical direction, a horizontal operating signal corresponding to the operation of the main lever 1a in the horizontal direction (or back-and-forth direction), a rotational operating signal corresponding to the operation of the rotating knob 1b, a right-and-left-direction selection operating signal corresponding to the operation of the right-and-left-direction selection lever 1f, and a vertical-direction selection operating signal corresponding to the operation of the vertical-direction selection lever 1e, to the switch function selector (not shown).

The switch function selector according to the present embodiment may have a similar construction to that of the switch function selector 21 shown in the first embodiment or may have a similar construction to that of the switch function selector 23 shown in the second embodiment.

In this manner, the right-and-left-direction selection lever 1f can be provided so as to be moved in the axial direction of the main lever 1a. Further, the right-and-left-direction selection lever 1f may be provided rotatably about the axis of the main lever 1a.

### Fifth Embodiment

As a fifth embodiment, the selection operation on the display screen of the display unit 40 of the navigation device 3, using the operating lever 1 shown in FIG. 10 in which the right-and-left-direction selection lever 1d is rotatable in a rotation axial direction of the main lever 1a, will be described. Note that the right-and-left-direction selection lever 1d outputs the right-and-left-direction selection operating signal corresponding to the tilting operation and a rotational operating signal corresponding to a rotational operation.

FIG. 12 shows a display example when multiple windows are three-dimensionally arranged by starting of multiple applications on the display screen of the display unit 40. As shown in FIG. 12, when multiple windows are three-dimensionally arranged by starting of multiple applications on the display screen of the display unit 40, the control circuit 38 of the navigation device 3 performs display selection of a window to become active based on the rotation operating signal corresponding to the operation of the rotating knob 1b, and performs selection of an application to become active based on the rotational operating signal corresponding to the rotational operation of the right-and-left-direction selection lever 1d.

Further, the control circuit 38 changes a select-displayed item in the right-and-left direction based on the right-and-left-direction selection operating signal corresponding to the tilting operation of the right-and-left-direction selection lever 1d. Further, the control circuit changes a select-displayed item in the vertical direction based on the vertical-direction selection operating signal corresponding to the operation of the vertical-direction selection lever 1e.

Further, the control circuit 38 moves the position of the active window in the vertical direction based on the vertical operation signal corresponding to the operation of the main lever 1a in the vertical direction.

As described above, the control circuit 38 performs various operations based on the various operating signals inputted from the operating lever 1.

### Sixth Embodiment

As a sixth embodiment, the selection operation on the display screen of the display unit 40 of the navigation device 3 with the operating lever 1 will be described.

FIGS. 13A and 13B illustrate display examples when multiple windows are stereoscopically displayed by starting of multiple applications on the display screen of the display unit 40. FIG. 13A shows a display example when windows are rotated about a vertical direction in the drawing as a rotation axis in correspondence with the operation of the rotating knob 1b of the operating device 2. FIG. 13B shows a display example when windows are rotated about a horizontal direction in the drawing as a rotation axis in correspondence with the operation of the rotating knob 1b of the operating device 2.

The control circuit 38 of the navigation device 3 rotates these windows based on the rotational operating signal corresponding to the operation of the rotating knob 1b of the operating device 2, and displays an active window in an enlarged size in a front position of the screen.

Further, the user can change the transparency of these windows in accordance with a function setting screen. Even when the windows are rotated, the user can visually check the contents of a window displayed in a rear position of the screen by changing the transparency of these windows.

Note that in the present embodiment, the windows are rotated in correspondence with the operation of the rotating knob 1b of the operating device 2. However, it may be arranged such that the windows are rotated in correspondence with the operation of the operating lever 1 in the vertical direction or horizontal direction.

Further, in the present embodiment, the windows are rotated in correspondence with the operation of the rotating knob 1b of the operating device 2. However, it may be arranged such that the operating lever 1 is provided with multiple rotating knobs, and the rotation and transparency of the windows are separately operated by operations of these rotating knobs.

### Other Embodiments

The present invention is not limited to the above embodiments but can be implemented in various forms based on the subject matter of the present invention.

For example, in the above embodiments, a navigation device is used as an in-vehicle electronic device, however, the in-vehicle electronic device is not limited to the navigation device. For example, an audio device, a head-up display or the like may be used as the in-vehicle electronic device.

Further, in the above embodiments, the switch function selectors 21 and 23 respectively have the selection switch to output the operating signal inputted from the lever switch 20 to the turn-signal lamp controller 50 and the illumination lamp controller 51 or to the navigation device 3 and the microcomputer to control the selection switch. However, it may be arranged such that the microcomputer itself selectively outputs the operating signal inputted from the lever switch 20 without the selection switch.

Further, the above embodiments describe the operation of the in-vehicle electronic device using an operating lever that operates turn-signal lamps of a vehicle as a vehicle operating lever. However, it may be arranged such that the in-vehicle electronic device is operated by using an operating lever that operates wipers. In this case, as vehicle surrounding circumstances, a rainfall status around the vehicle is determined by using a raindrop sensor. When it is determined that it is necessary to operate the wipers, an operating signal corresponding to the operation of the operating lever is outputted to the wipers. When it is determined that it is not necessary to operate the wipers, an operating signal corresponding to the operation of the operating lever is outputted to the in-vehicle electronic device.

Further, the right-and-left-direction selection lever 1d, 1f can be designed to output an operating signal used dedicatedly for the in-vehicle electronic devices such as the navigation device, instead for the turn-signal lamps and/or illumination lamps.

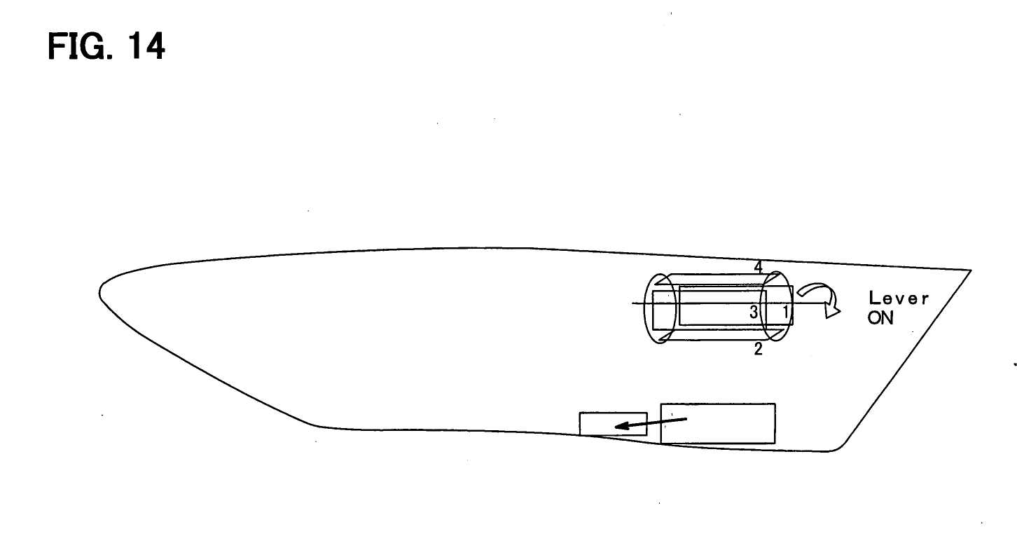

Further, as shown in FIG. 14, the display unit 40 can be replaced with a display formed on a windshield (or windshield display).

Note that the processings at the respective steps of the flowcharts in FIGS. 3A and 3B and FIG. 9 are means or units for realizing the respective functions. Further, the switch function selectors 21 and 23 may be realized with hardware as well as software as described in the above embodiments.

It will be obvious to those skilled in the art that various changes may be made in the above-described embodiments of the present invention. However, the scope of the present invention should be determined by the following claims.

What is claimed is:

1. An operating device comprising:
an operating signal output unit for outputting an operating signal corresponding to an operation of an operating lever, which is used for controlling at least one of a turn-signal lamp and an illumination lamp of a vehicle;
an information acquisition unit for acquiring information;
a determination unit for determining based on the information acquired by the information acquisition unit whether or not the operating lever needs operating; and
an output selection unit for outputting an operating signal from the operating signal output unit
(i) to a control unit for controlling the at least one of the turn-signal lamp and the illumination lamp when the operating lever is determined to need operating, and
(ii) to an in-vehicle electronic device for performing an operation corresponding to the operating signal when the operating lever is determined to not need operating.

2. The operating device of claim 1, wherein:
the information acquired by the information acquisition unit includes first information having (i) positional information of the vehicle and (ii) road information of roads surrounding the vehicle;
the determination unit determines based on the acquired first information whether the vehicle is within a given range from an intersection; and
the operating lever is determined
(i) to need operating when the vehicle is determined to be within the given range, and
(ii) to not need operating when the vehicle is determined to be not within the given range.

3. The operating unit of claim 2, wherein:
the information acquired by the information acquisition unit further includes second information indicating whether the vehicle is running;
the determination unit determines based on the acquired first information and the acquired second information whether the vehicle is outside of a give range from an intersection and whether the vehicle is running; and
the operating lever is determined
(i) to need operating when the vehicle is determined to be outside of the given range and be running, and
(ii) to not need operating when the vehicle is determined to be outside of the given range and not be running.

4. The operating unit of claim 1, wherein:
the information acquired by the information acquisition unit includes third information relating to brightness in an area surrounding the vehicle;
the determination unit determines based on the acquired third information whether the brightness is less than a given value; and
the operating lever is determined
(i) to need operating when the brightness is determined to be less than the given value, and
(ii) to not need operating when the brightness is determined to be not less than the given value.

5. The operating device of claim 1, wherein:
the in-vehicle electronic device conducts a selection display for selecting items based on the operating signal outputted from the output section unit; and
the operating lever includes a determination button to output to the in-vehicle electronic device an operating signal to determine selection for the items in the selection display based on an operation of a user.

6. The operating device of claim 1, wherein
the operating lever includes an attached operating unit to output an operating signal for operating the in-vehicle electronic device.

7. The operating device of claim 6, wherein
the operating signal outputted from the attached operating unit is used only for operating the in-vehicle electronic device.

8. An in-vehicle electronic device communicated with an operating device,
the operating device including:
an operating signal output unit for outputting an operating signal corresponding to an operation of an operating lever, which is used for controlling at least one of a turn-signal lamp and an illumination lamp of a vehicle;
an information acquisition unit for acquiring information;
a determination unit for determining based on the information acquired by the information acquisition unit whether or not the operating lever needs operating; and
an output selection unit for outputting an operating signal from the operating signal output unit
(i) to a control unit for controlling the at least one of the turn-signal lamp and the illumination lamp when the operating lever is determined to need operating, and
(ii) to the in-vehicle electronic device for performing an operation corresponding to the operating signal when the operating lever is determined to not need operating,
the in-vehicle electronic device comprising:
an operating unit for outputting an operating signal corresponding to an operation of a user;
an operating signal acquisition unit for acquiring the operating signal outputted from the output selection unit of the operating device; and
a control unit for performing an operation based on one of (i) the operating signal outputted by the operating unit and (ii) the operating signal acquired by the operating signal acquisition unit.
